(19) United States
(12) Patent Application Publication
(10) Pub. No.: US 2013/0271437 A1
(43) Pub. Date: Oct. 17, 2013

(54) COLOR PERFORMANCE OF REFLECTIVE-DISPLAYS USING ENVIRONMENTAL SPECTRAL SENSING

(71) Applicants: James Randolph Webster, San Jose, CA (US); Marek Mienko, San Jose, CA (US)

(72) Inventors: James Randolph Webster, San Jose, CA (US); Marek Mienko, San Jose, CA (US)

(73) Assignee: QUALCOMM MEMS TECHNOLOGIES, INC., San Diego, CA (US)

(21) Appl. No.: 13/446,670

(22) Filed: Apr. 13, 2012

(51) Int. Cl. G09G 5/00

(52) U.S. Cl. 345/207

(57) ABSTRACT

This disclosure provides systems, methods and apparatus, including computer programs encoded on computer storage media, related to an electronic device having a display, a spectrum sensing arrangement, and a display controller. The spectrum sensing arrangement includes a photodiode, a first portion of the photodiode being configured to generate a first signal, the first signal being responsive to an intensity of ambient visible light, and a second portion of the photodiode being configured to generate a second signal, the second signal being representative of an intensity of ambient infrared light. The display controller, in communication with the spectrum sensing arrangement, makes a comparison of the first signal and the second signal and controls the display so as to dynamically adjust a color bias of the display responsive to the comparison.

### TECHNICAL FIELD

This disclosure relates to a reflective display, and, more specifically, to improving the color performance of the reflective display by using environmental spectral sensing.

### DESCRIPTION OF THE RELATED TECHNOLOGY

Electromechanical systems (EMS) include devices having electrical and mechanical elements, actuators, transducers, sensors, optical components (such as mirrors and optical film layers) and electronics. EMS can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term IMOD or interferometric light modulator refers to a device that selectively absorbs and/or reflects light using the principles of optical interference. In some implementations, an IMOD may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the IMOD. IMOD devices have a wide range of applications, and are anticipated to be used in improving existing products and creating new products, especially those with display capabilities, such as personal computers and personal electronic devices (PED's).

Electronic displays based on reflective elements (“reflective displays”) largely rely on reflection of ambient light to produce a visible image. Because the illumination source of a reflective display comes from its external environment, it consumes less power than, for example, a non-reflective display such as a conventional LCD or light emitting diode (LED) display. Thus, reflective displays may be advantageously employed in PED's. Moreover, reflective displays can provide readily visible images in bright ambient environments, including direct sunlight, where self-illuminated displays often provide a poor user experience.

Image quality of reflective displays, however, can be adversely affected when the spectral characteristics of the ambient light environment vary from a nominal characteristic. The presence or absence of particular hues in the ambient light illuminating the display can significantly alter the perceived color response of the display. In a color reflective display, for example, a display output color as perceived when the ambient light is incandescent, may be different from the output color perceived when the ambient light is fluorescent light, or direct or reflected sunlight. For example, an apparent hue of the image may be skewed noticeably toward the blue or red ends of the visible spectrum.

As a result, techniques for improving the color performance of reflective-displays by mitigating the adverse affects on image quality are desirable.

### SUMMARY

The systems, methods and devices of the disclosure each have several innovative aspects, no single one of which is solely responsible for the desirable attributes disclosed herein.

One innovative aspect of the subject matter described in this disclosure may be implemented in an electronic device having a reflective display, a spectrum sensing arrangement, and a display controller. The spectrum sensing arrangement may include a photodiode, a first portion of the photodiode being configured to generate a first signal, the first signal being responsive to an intensity of ambient visible light, and a second portion of the photodiode being configured to generate a second signal, the second signal being representative of an intensity of ambient infrared light. The display controller, in communication with the spectrum sensing arrangement, may be configured to make a comparison of the first signal and the second signal and control the display so as to dynamically adjust a color bias of the reflective display responsive to the comparison.

Another innovative aspect of the subject matter described in this disclosure may be implemented in an apparatus that includes a reflective display and a spectrum sensing arrangement. The spectrum sensing arrangement may include a photodiode, a first portion of the photodiode being configured to generate a first signal that is representative of an intensity of ambient visible light, and a second portion of the photodiode being configured to generate a second signal that is representative of an intensity of ambient infrared light. The apparatus also includes a display controller in communication with the spectrum sensing arrangement, the display controller configured to make a comparison of the first signal and the second signal, and dynamically adjust a color bias of the reflective display responsive to the comparison.

The comparison may indicate a relative intensity of ambient infrared light compared to ambient visible light. The display controller may be configured to adjust the color bias of the reflective display toward more blue when the relative intensity of ambient infrared light compared to ambient visible light is greater than a first threshold. The display controller may be configured to adjust the color bias of the reflective display toward more red when the relative intensity of ambient infrared light compared to ambient visible light is less than a second threshold.

The display controller may be configured to access a look-up table (LUT) and/or a formula that provides a target color bias corresponding to the comparison, and to dynamically adjust, responsive to the comparison, the color bias toward the target color bias.

The apparatus may further include an auxiliary light source. The display controller may be configured to dynamically adjust the color bias of the reflective display by adjusting one or both of an intensity and a color of the auxiliary light source. The auxiliary light source may include a front light.

The apparatus also may include a color processing engine. The reflective display may include a plurality of interferometric modulator (IMOD) devices. The color processing engine may provide bi-level or analog control of the IMOD devices. The display controller may be configured to dynamically adjust the color bias by adjusting an output of the color processing engine.

Another innovative aspect of the subject matter described in this disclosure may be implemented in an apparatus that includes a reflective display, a spectrum sensing arrangement; an auxiliary light source; and a display controller. The display controller may be in communication with the spectrum sensing arrangement and be configured to dynamically adjust a color bias of the reflective display by adjusting an intensity and/or a color of the auxiliary light source, responsive to a comparison of at least a first signal and a second signal from the spectrum sensing arrangement. The first signal may be indicative of an intensity of ambient visible light, and the second signal may be representative of an intensity of ambient infrared light.

The spectrum sensing arrangement may include a photodiode, a first portion of the photodiode being configured to generate the first signal, and a second portion of the photodiode configured to generate the second signal. The comparison may indicate a relative intensity of ambient infrared light compared to ambient visible light. The display controller may be configured to adjust the color bias of the reflective display toward more blue when the relative intensity of ambient infrared light compared to ambient visible light is greater than a first threshold, and to adjust the color bias of the reflective display toward more red when the relative intensity of ambient infrared light compared to ambient visible light is less than a second threshold. The auxiliary light source may include a front light.

Another innovative aspect of the subject matter described in this disclosure may be implemented in a portable electronic device (PED) including a reflective display, an ambient light sensor, an infrared (IR) proximity sensor; and a display controller. The display controller may be configured to dynamically adjust a color bias of the reflective display responsive to a comparison of at least a first signal from the ambient light sensor and a second signal from the IR proximity sensor.

The PED may further include an auxiliary light source, and the display controller may be configured to dynamically adjust the color bias of the reflective display by adjusting an intensity and/or a color of the front light.

Another innovative aspect of the subject matter described in this disclosure may be implemented in a method, the method that involves receiving, at a display controller, a first signal and a second signal output by a spectrum sensing arrangement including a photodiode, where a first portion of the photodiode is configured to generate a first signal representative of an intensity of ambient visible light, and a second portion of the photodiode is configured to generate a second signal representative of an intensity of ambient infrared light. The method further involves the display controller making a comparison of the first signal and the second signal and dynamically adjusting a color bias of a reflective display responsive to the comparison.

Details of one or more implementations of the subject matter described in this specification are set forth in the accompanying drawings and the description below. Although the examples provided in this summary are primarily described in terms of MEMS-based displays, the concepts provided herein apply to other types of displays, such as organic light-emitting diode (“OLED”) displays and field emission displays. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 IMOD display.

FIG. 3 shows an example of a diagram illustrating movable reflective layer position versus applied voltage for the IMOD of FIG. 1.

FIG. 4 shows an example of a table illustrating various states of an IMOD when various common and segment voltages are applied.

FIG. 5A shows an example of a diagram illustrating a frame of display data in the 3×3 IMOD display of FIG. 2.

FIG. 5B shows an example of a timing diagram for common and segment signals that may be used to write the frame of display data illustrated in FIG. 5A.

FIG. 6A shows an example of a partial cross-section of the IMOD display of FIG. 1.

FIGS. 6B-6E show examples of cross-sections of varying implementations of IMODs.

FIG. 7 shows an example of a flow diagram illustrating a manufacturing process for an IMOD.

FIGS. 8A-8E show examples of cross-sectional schematic illustrations of various stages in a method of making an IMOD.

FIG. 9 shows an example of a block diagram of an electronic device having a reflective display.

FIG. 10 shows an example of plots of intensity as a function of wavelength for various types of light sources.

FIG. 11 shows an example of a plot of spectral power distribution for a standard illuminant.

FIG. 12 shows an example of plots of response characteristics of various sensors as a function of wavelength.

FIG. 13 shows an example of a block diagram of an electronic device having a reflective display.

FIG. 14 shows an example of a block diagram of an electronic device having a reflective display.

FIGS. 15A and 15B show examples of photodiodes configured to detect a spectrum characteristic of ambient light.

FIG. 16 shows an example of an implementation where photodiode is disposed behind a lens.

FIG. 17 shows an example of a personal electronic device (PED) having a reflective display.

FIG. 18 shows an example of a method for adjusting a color bias of a reflective display based on analysis of signals output from a spectral sensing arrangement.

FIG. 19 shows an example of a method for adjusting a color bias of a reflective display.

FIGS. 20A and 20B show examples of system block diagrams illustrating a display device that includes a plurality of IMODs.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Described herein below are new techniques incorporating, in an electronic device having a reflective display, a spectrum sensing arrangement and a display controller. The spectrum sensing arrangement may include a photodiode, a first portion of the photodiode being configured to generate a first signal, the first signal being responsive to an intensity of ambient visible light, and a second portion of the photodiode being configured to generate a second signal, the second signal being representative of an intensity of ambient infrared light. The display controller, in communication with the spectrum sensing arrangement, may be configured to make a comparison of the first signal and the second signal and control the display so as to dynamically adjust a color bias of the reflective display responsive to the comparison. In some implementations, the display controller may be configured to adjust the color bias, at least in part, based on either or both of content being displayed and viewer preferences.

Particular implementations of the subject matter described in this disclosure can be implemented to realize one or more of the following potential advantages. The image quality of a reflective display of an electronic device can be substantially improved in the face of changing ambient light conditions by dynamically adjusting a color bias of the display, responsive to signals received from a spectrum sensing arrangement. The spectrum sensing arrangement itself may be relatively simple, and consist of off the shelf components. In some implementations, the spectrum sensing arrangement may largely or entirely consist of electronic devices that are already, for other reasons, incorporated in the electronic device. For example, signals output by an ambient light sensor (ALS) and an infrared (IR) proximity sensor (devices which are routinely incorporated in some types of electronic devices) may be used as inputs to a display controller. The display controller can make a comparison of the signals output by the spectrum sensing arrangement and control the display so as to dynamically adjust a color bias of the reflective display responsive to the comparison. As a result, adverse effects on display output color quality caused by changing ambient light conditions may be minimized or eliminated, without substantially increasing the cost or complexity of the electronic device.

Moreover, in certain lighting conditions (such as near-monochromatic conditions including, for example, outdoor sodium vapor lighting and darkroom illumination) operating a display in high-contrast mode may be contemplated. In such a high contrast mode, in some implementations, only a specific subset of color elements may be used. For example, in a red-only environment IMODs ordinarily configured to modulate green and blue light may be disabled. As a result, display power consumption may be reduced with no loss of image clarity because such IMODs would not be operable to modulate red light.

As a further example the display may be operated in a high-resolution, monochromatic, mode, responsive to ambient lighting conditions. In such a mode, all IMODs may be configured to modulate light of a particular wavelength, responsive to a detected narrow band ambient light environment and a high-resolution monochrome image may be produced. For example, original image data may be sub-sampled to individually address each IMOD in the display. In a dark or nearly dark environment, an artificial narrow band light input to the display may be provided by a supplemental illumination from a front light. The front light, for example may be configured to provide a narrow band spectrum (for example, from a red or RGB LED). There are potential industrial and some military applications of such an adaptable display behavior.

Although much of the description herein pertains to IMOD displays, many such implementations could be used to advantage in other types of reflective displays, including but not limited to electrophoretic ink displays and displays based on electrowetting technology. Moreover, while the IMOD displays described herein generally include red, blue and green pixels, many implementations described herein could be used in reflective displays having other colors of pixels, such as having violet, yellow-orange and yellow-green pixels. Moreover, many implementations described herein could be used in reflective displays having more colors of pixels, such as having pixels corresponding to 4, 5, or more colors. Some such implementations may include pixels corresponding to red, blue, green and yellow. Alternative implementations may include pixels corresponding to at least red, blue, green, yellow and cyan.

An example of a suitable device, to which the described implementations may apply, is a reflective EMS or MEMS-based display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the IMOD. The reflectance spectrums of IMODs can create fairly broad spectral bands which can be shifted across the visible wavelengths to generate different colors. The position of the spectral band can be adjusted by changing the thickness of the optical resonant cavity. One way of changing the optical resonant cavity is by changing the position of the reflector.

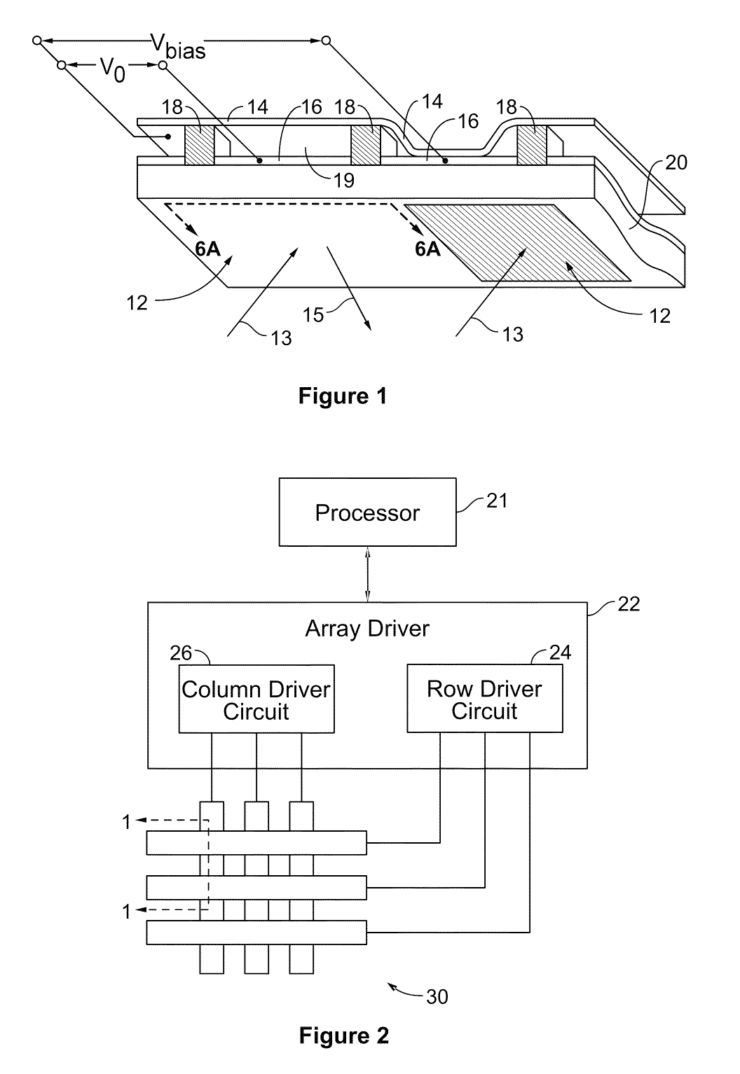

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent IMODs 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, electrically more conductive layers or portions (e.g., of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be approximately less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, a voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 IMOD display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example, a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

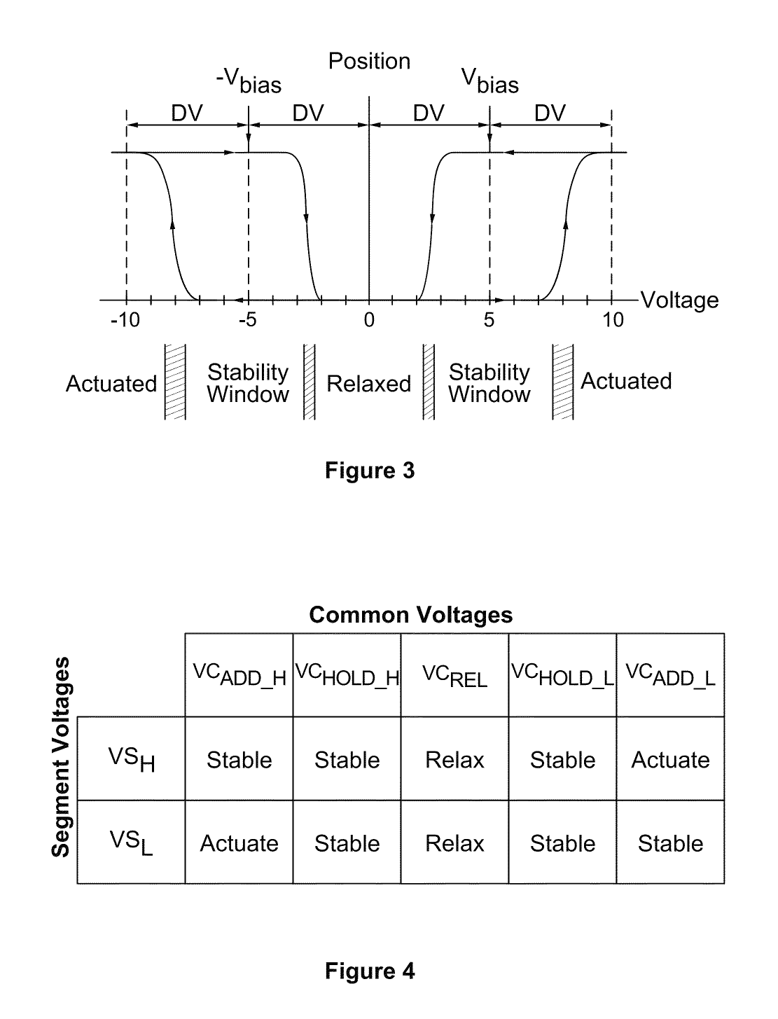

FIG. 3 shows an example of a diagram illustrating movable reflective layer position versus applied voltage for the IMOD of FIG. 1. For MEMS IMODs, the row/column (i.e., common/segment) write procedure may take advantage of a hysteresis property of these devices as illustrated in FIG. 3. An IMOD may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts; however, the movable reflective layer does not relax completely until the voltage drops below 2 volts. Thus, a range of voltage, approximately 3 to 7 volts, in this example, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels can be exposed to a steady state or bias voltage difference of approximately 5 volts in this example, such that they remain in the previous strobing state. In this example, after being addressed, each pixel sees a potential difference within the “stability window” of about 3-7 volts. This hysteresis property feature enables the pixel design, such as that illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an IMOD when various common and segment voltages are applied. As will be understood by one having ordinary skill in the art, the “segment” voltages can be applied to either the column electrodes or the row electrodes, and the “common” voltages can be applied to the other of the column electrodes or the row electrodes.

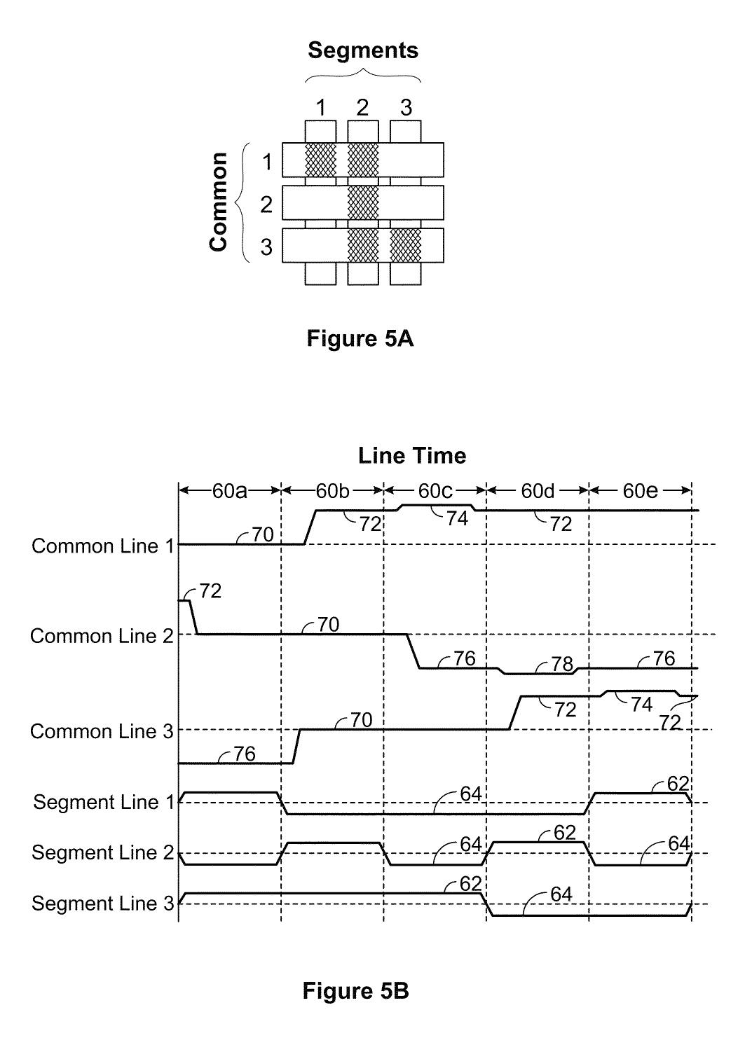

As illustrated in FIG. 4 (as well as in the timing diagram shown in FIG. 5B), when a release voltage VC_{REL} is applied along a common line, all IMOD elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator pixels (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the IMOD will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 IMOD display of FIG. 2. FIG. 5B shows an example of a timing diagram for common and segment signals that may be used to write the frame of display data illustrated in FIG. 5A. The signals can be applied to a 3×3 array, similar to the array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, for example, a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the IMODs, as none of common lines 1, 2 or 3 are being exposed to voltage levels causing actuation during line time 60a (i.e., VC_{REL}−relax and VC_{HOLD}_{_{—}}_{L}−stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

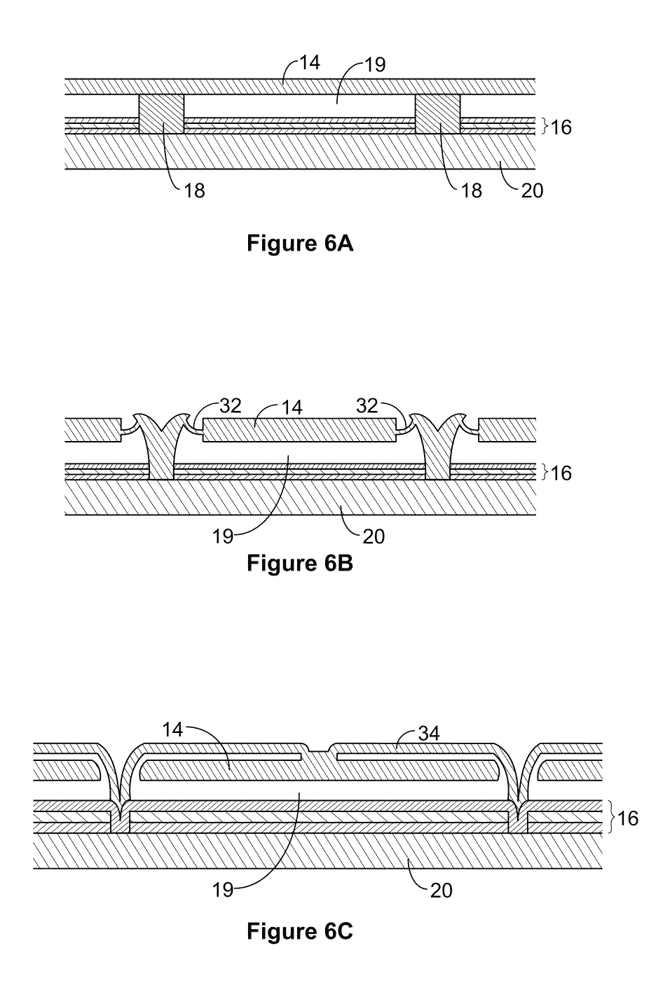

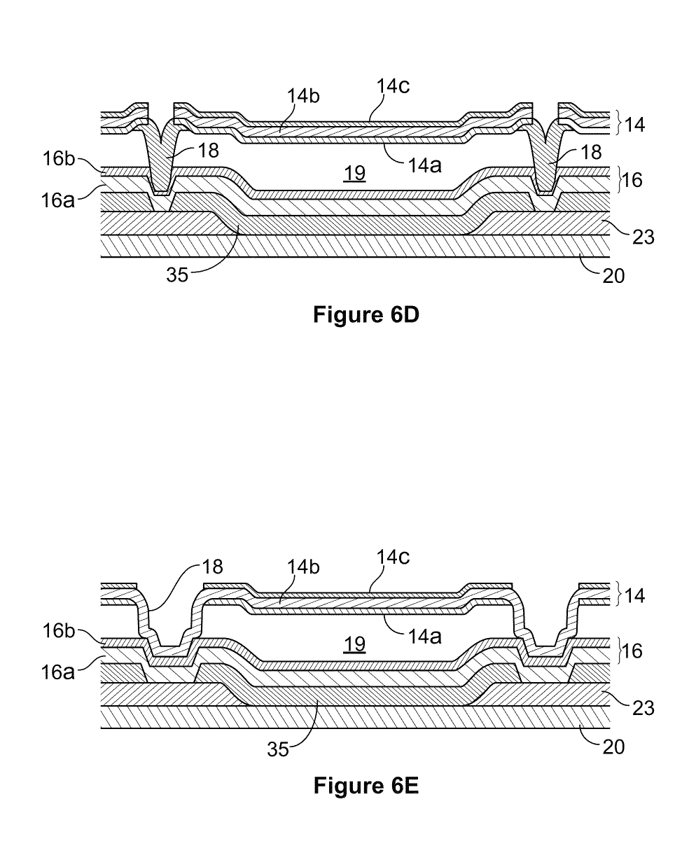

The details of the structure of IMODs that operate in accordance with the principles set forth above may vary widely. For example, FIGS. 6B-6E show examples of cross-sections of varying implementations of IMODs, including the movable reflective layer 14 and its supporting structures. FIG. 6A shows an example of a partial cross-section of the IMOD display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (such as between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the IMOD is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer. In some implementations, the optical absorber 16a is an order of magnitude (ten times or more) thinner than the movable reflective layer 14. In some implementations, optical absorber 16a is thinner than reflective sub-layer 14a.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as patterning.

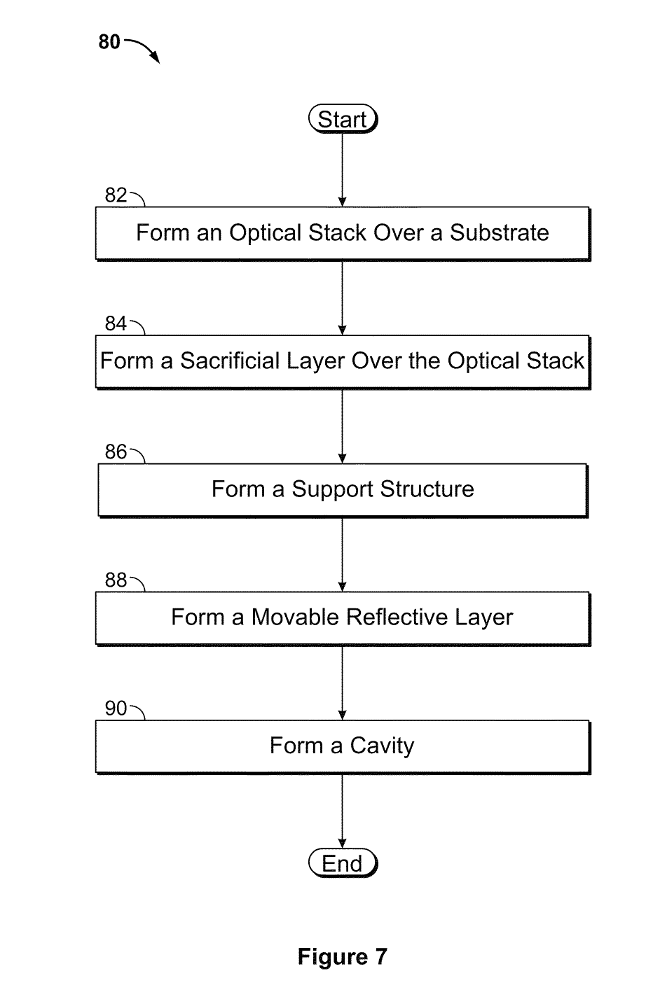

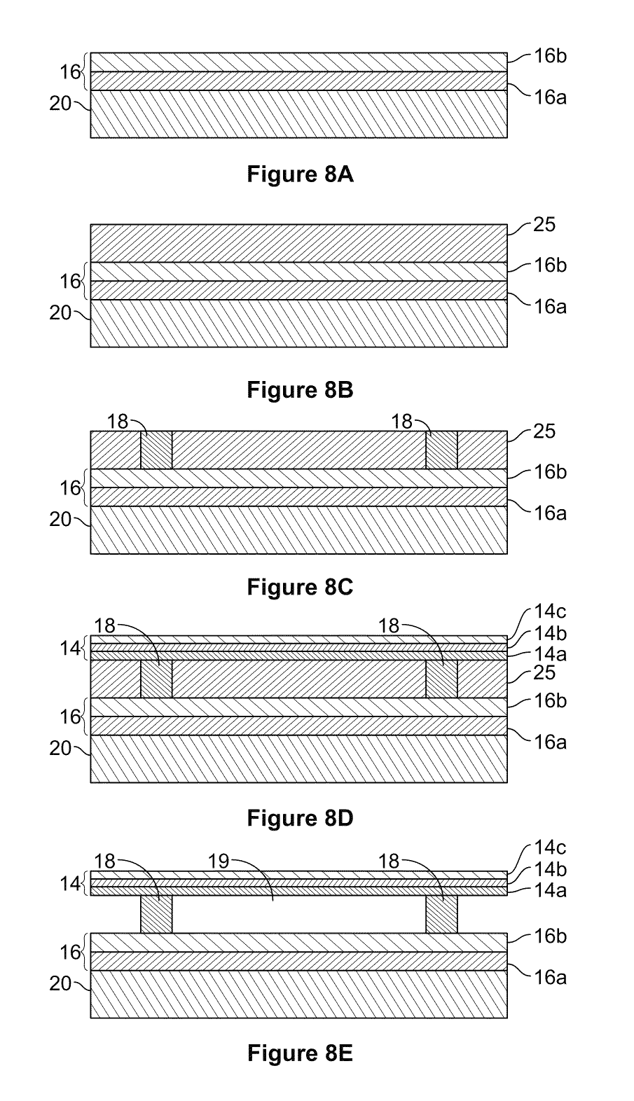

FIG. 7 shows an example of a flow diagram illustrating a manufacturing process 80 for an IMOD, and FIGS. 8A-8E show examples of cross-sectional schematic illustrations of corresponding stages of such a manufacturing process 80. In some implementations, the manufacturing process 80 can be implemented to manufacture an electromechanical systems device such as IMODs of the general type illustrated in FIGS. 1 and 6. The manufacture of an electromechanical systems device also can include other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, such as cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display. It is noted that FIGS. 8A-8E may not be drawn to scale. For example, in some implementations, one of the sub-layers of the optical stack, the optically absorptive layer, may be very thin, although sub-layers 16a, 16b are shown somewhat thick in FIGS. 8A-8E.

The process 80 continues at block 84 with the formation of a sacrificial layer 25 over the optical stack 16. The sacrificial layer 25 is later removed (see block 90) to form the cavity 19 and thus the sacrificial layer 25 is not shown in the resulting IMODs 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as post 18, illustrated in FIGS. 1, 6 and 8C. The formation of the post 18 may include patterning the sacrificial layer 25 to form a support structure aperture, then depositing a material (such as a polymer or an inorganic material such as silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps including, for example, reflective layer (such as aluminum, aluminum alloy, or other reflective layer) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated IMOD formed at block 88, the movable reflective layer 14 is typically not movable at this stage. A partially fabricated IMOD that contains a sacrificial layer 25 also may be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, such as cavity 19 illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, by exposing the sacrificial layer 25 to a gaseous or vaporous etchant, such as vapors derived from solid XeF₂, for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

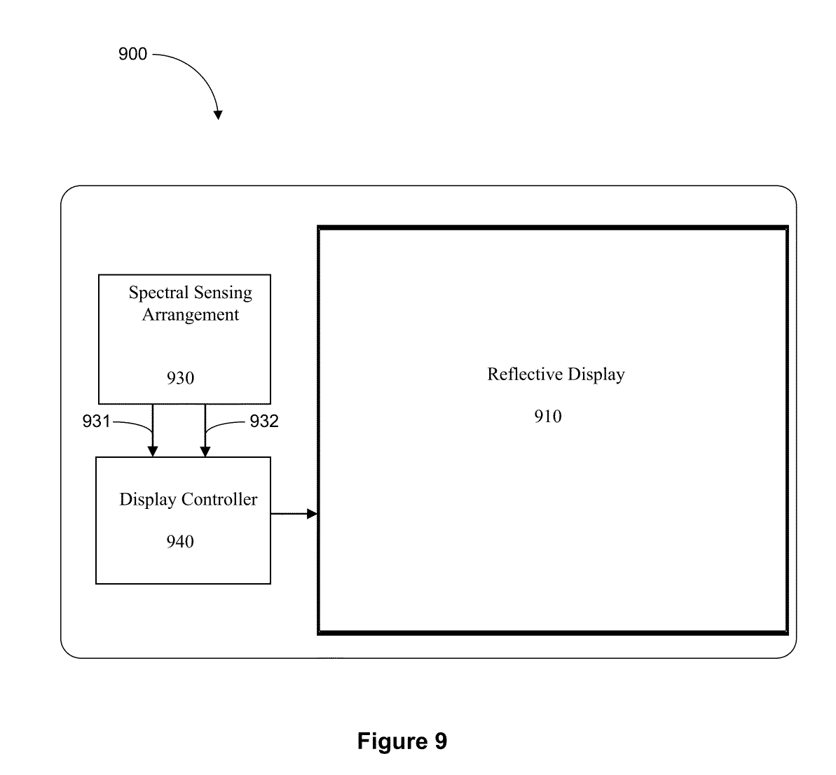

FIG. 9 shows an example of a block diagram of an electronic device having a reflective display. The electronic device 900 may include a reflective display 910, a display controller 940, and a spectral sensing arrangement 930. The display controller 940 may be configured, responsive to a first signal 931 and a second signal 932 from the spectrum sensing arrangement 930, to dynamically adjust a color bias of the reflective display 910. In some implementations, the first signal 931 may be representative of an intensity level of visible ambient light while the second signal 932 may be representative of an intensity level of infrared (IR) ambient light.

As described in more detail herein below, the spectrum sensing arrangement 930, in some implementations, may include a photo diode, a first portion of which is configured to generate the first signal 931, and a second portion of which is configured to generate the second signal 932. In some implementations, a single photodiode device may be so configured by placement of one or more appropriate thin film filter(s) over at least part of a sensing portion of the photodiode device.

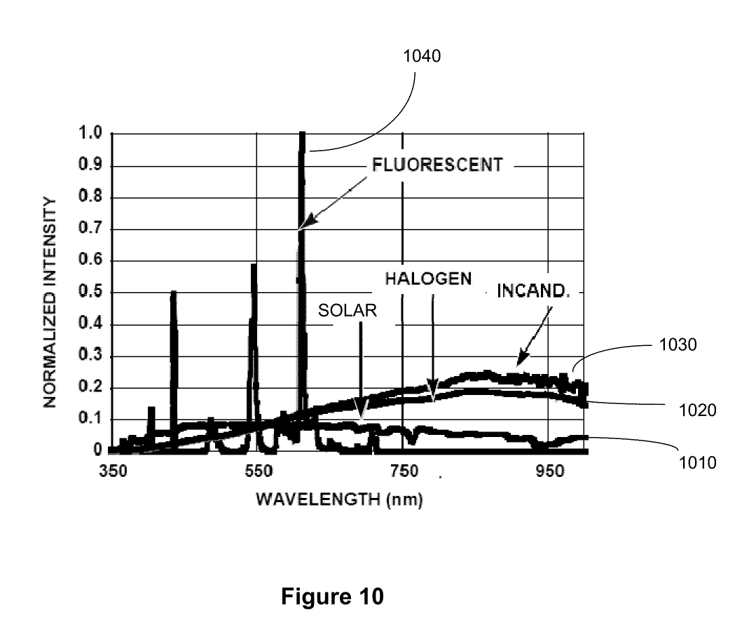

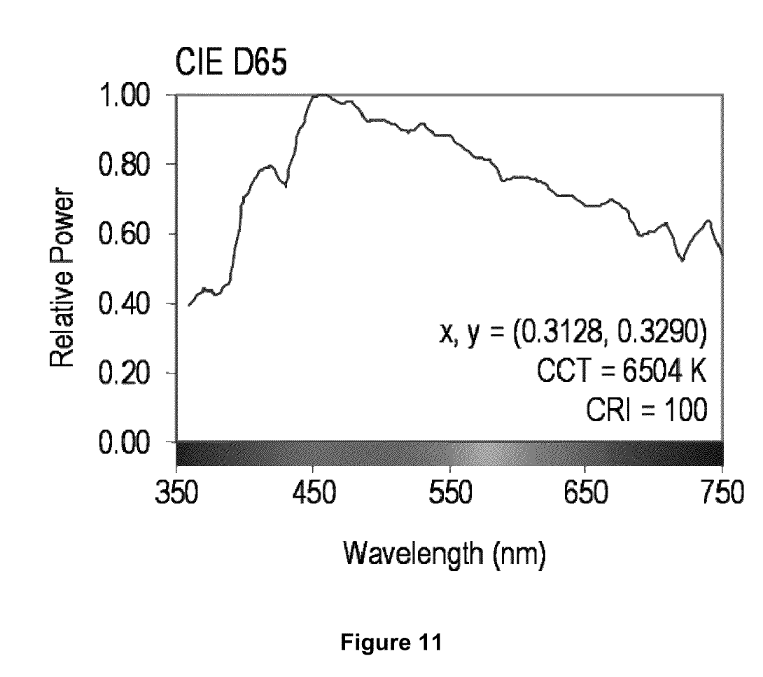

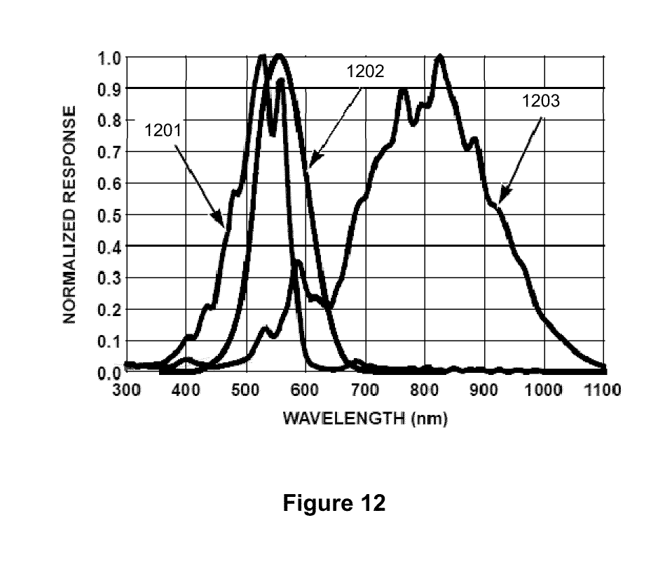

Additional features of this disclosure may be better appreciated by referring first to FIGS. 10-12. FIG. 10 shows an example of plots of intensity as a function of wavelength for various types of light sources. FIG. 11 shows an example of a plot of spectral power distribution for a standard illuminant. FIG. 12 shows an example of plots of response characteristics of various sensors as a function of wavelength. Referring now to FIG. 10, the normalized intensity of various ambient light sources is plotted as a function of wavelength. More particularly, it may be observed that, relative to the normalized plot of solar ambient light intensity 1010, which has a peak at about 450 nanometers (nm), normalized plots of halogen light intensity 1020 and incandescent light intensity 1030 each exhibit peak intensity at about 850 nm. Put another way, solar ambient light may be said to be blue-shifted whereas ambient light from halogen and incandescent light sources may be said to be red-shifted. On the other hand, normalized plot of fluorescent light intensity 1040 may be observed to have pronounced peaks at 400 nm, 550 nm and 600 nm, and relatively low intensity at other wavelengths.

As noted above, the output color characteristics of a reflective display can be significantly affected by spectrum bias of ambient light, such as the above noted blue-shift of solar ambient light and red-shift of halogen and incandescent light. Nevertheless, reflective display controllers are generally designed to cause a display to output colors based on a single assumed ambient spectrum. For example, Standard Illuminant D65, defined by the International Commission on Illumination (CIE), and illustrated in FIG. 11, may be the assumed ambient light environment. Standard Illuminant D65 (“CIE D65”) corresponds approximately to a midday, outdoor daylight ambient environment. As a result, a color output of a reflective display controlled by such a reflective display controller may be of good perceived quality in daylight ambient light conditions, and less satisfactory in indoor ambient light conditions.

Users of electronic devices, however, desire that color output of a display be of uniformly good quality, irrespective of the ambient light conditions, and irrespective of dynamic changes in the ambient light conditions. For example, when the user takes a portable electronic device (PED) from an outdoor environment to an indoor environment, or from an environment illuminated by incandescent lights to one illuminated by fluorescent lights, the user does not expect to perceive changes in the color output of the PED's display.

The above noted user expectation may be met, advantageously, by configuring a display controller to exploit information about the ambient light characteristics that is already collected for other purposes by devices commonly implemented on electronic devices. For example, most modern PEDs include one or more photo detecting elements for detecting characteristics of ambient light, such as an ambient light sensor (ALS) and an IR/proximity sensor. An ALS may be used, for example, to increase or decrease the brightness of a display based on a detected general intensity of ambient visible light. An IR/proximity sensor may be used to detect the proximity of a person or object. FIG. 12 shows a plot of response characteristics 1201 of an ALS and a plot of response characteristics 1203 of an IR/proximity sensor. For reference, FIG. 12 also shows a plot of the response characteristics 1202 of the human eye. It may be observed that plots of response characteristics 1201 and 120 exhibits a pronounced peak at approximately 540 nm, whereas plot of response characteristics 1203 exhibits a pronounced peak at approximately 830 nm.

Thus, in some implementations, the spectrum sensing arrangement 930 depicted in FIG. 9, may include an existing ALS and an existing IR proximity sensor. The existing ALS, in such implementations, may output the first signal 931, representative of an intensity level of visible ambient light while the existing IR proximity sensor may output the second signal 932, representative of an intensity level of infrared (IR) ambient light.

Whether or not spectrum sensing arrangement 930 includes an existing ALS and an existing IR proximity sensor, the display controller 940 may be configured to make a comparison of the first signal 931 and the second signal 932 from the spectrum sensing arrangement 930. In some implementations, the comparison may indicate a relative intensity of ambient infrared light compared to ambient visible light.

The display controller 940 may be further configured to adjust the color bias of the reflective display 910 toward more blue when the relative intensity of ambient infrared light compared to ambient visible light is high and to adjust the color bias of the reflective display 910 toward more red when the relative intensity of ambient infrared light compared to ambient visible light is low. In some implementations, when the relative intensity of ambient infrared light compared to ambient visible light is greater than a first threshold the color bias of reflective display 910 may be adjusted toward more blue. When the relative intensity of ambient infrared light compared to ambient visible light is less than a second threshold the color bias of reflective display 910 may be adjusted toward more red. The first threshold and the second threshold may be preset, or determined dynamically, either by display controller 940 or the user.

It will be appreciated that display controller 940 may be configured to process first signal 931 and second signal 932 in various ways in order to make a comparison indicative of a relative intensity of ambient infrared light compared to ambient visible light. For example, a difference and/or a ratio of first signal 931 and second signal 932 may be computed, with or without first normalizing the respective signals. As a further example, each of first signal 931 and second signal 932 may be compared to a standard, for example to CIE D65.

In some implementations, electronic device 900 may include a color processing engine (not illustrated) and reflective display 910 may include a number of IMOD devices (not illustrated). The color processing engine may provide bi-level or analog control of the IMOD devices. In such implementations, the display controller 940 may be configured to dynamically adjust the color bias of the reflective display 910 by adjusting an output of the color processing engine. The color processing engine may be implemented within the display controller 940, or be a separate device (for example, an application specific integrated circuit) or a software module stored on a non-transitory medium.

In some implementations, the display controller 940 may be configured to access a lookup table (LUT) and/or a formula that provides a target color bias corresponding to the comparison. The display controller 940 may dynamically adjust the color bias of reflective display 910 toward the target color bias.

In some implementations, the LUT and/or the formula may be based, at least in part, on an illumination model that is based at least in part on the content (e.g., text, image, or video) being displayed. Content may not significantly influence the target color bias, but it may be desired to have a different color bias for textual content as compared, for example, to video and/or photographic content, at least for some viewers. Thus, in some implementations, the display controller 940 may be configured to determine the amount of supplemental light based at least in part on the content being displayed. For example, when a photographic image is being displayed, the display controller 940 may determine the target color bias based at least in part on an illumination model that takes into account the content of an image being displayed.

In some implementations, the illumination model may have default parameters which may be adjusted based on viewer preferences. For example, the default parameters may be based on average preferences of a majority of viewers. To accommodate for differences in viewer preferences, some implementations of the electronic device 900 further may include a user interface with which a viewer can adjust default parameters.

In addition, certain implementations of electronic device 900 may store (such as on a memory device in communication with display controller 940) the viewer adjusted preference for an ambient lighting condition. The viewer preference for the lighting condition may be used to adjust the default parameters to provide a viewer illumination model. Upon use of the electronic device 900 in a different or same ambient lighting condition, certain implementations may update the viewer preference model. Thus, in these implementations, the display controller 940 may be configured to optionally access the viewer preference model. In addition, in some implementations, the display controller 940 may override a default illumination model and adjust the color bias of the reflective display 910 in conformance with the viewer preference model.

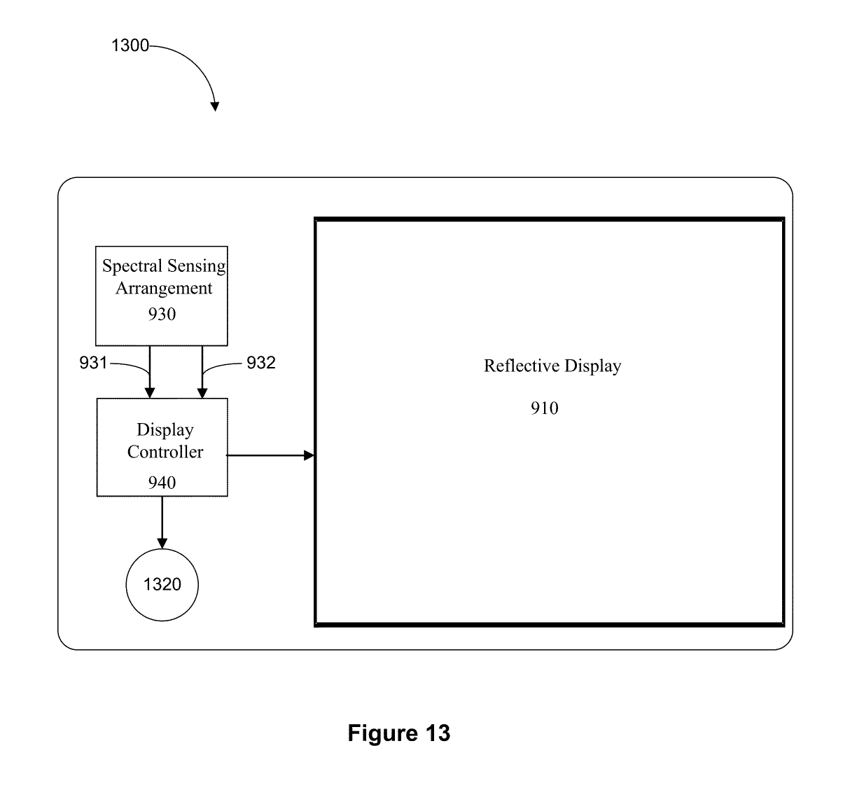

FIG. 13 shows an example of a block diagram of an electronic device having a reflective display. In the illustrated implementation, an electronic device 1300 may include the reflective display 910, the spectral sensing arrangement 930, the display controller 940, and, in addition, an auxiliary light source 1320 (which electronic device 900 does not necessarily include). The auxiliary light source 1320 may be configured to provide supplemental light to the reflective display 910 under control, at least in part, of the display controller 940. For example, the electronic device 1300 may provide front-light luminance by way of the auxiliary light source 1320 to the reflective display 910. In some implementations, the auxiliary light source 1320 may include a front light (not illustrated).

The spectral sensing arrangement 930 may be configured to determine spectral characteristics of ambient light illuminating the reflective display 910. The display controller 940 may be configured, responsive to the first signal 931 and the second signal 932 from the spectrum sensing arrangement 930, to dynamically adjust a color bias of the reflective display 910 by adjusting an intensity and/or a color of the auxiliary light source 1320.

In an implementation, the first signal 931 may be representative of an intensity level of visible ambient light while the second signal 932 may be representative of an intensity level of infrared (IR) ambient light. The display controller 940 may be configured to make a comparison of the first signal 931 and the second signal 932. Based on the comparison, an intensity and/or color of supplemental light from the auxiliary light source 1320 may be dynamically adjusted.

In addition, where the electronic device 1300 includes a color processing engine and the reflective display 910 includes a number of IMOD devices, the color processing engine may provide bi-level or analog control of the IMOD devices. In such implementations, the display controller 940 may be configured to dynamically adjust the color bias of the reflective display 910 by adjusting an output of the color processing engine.

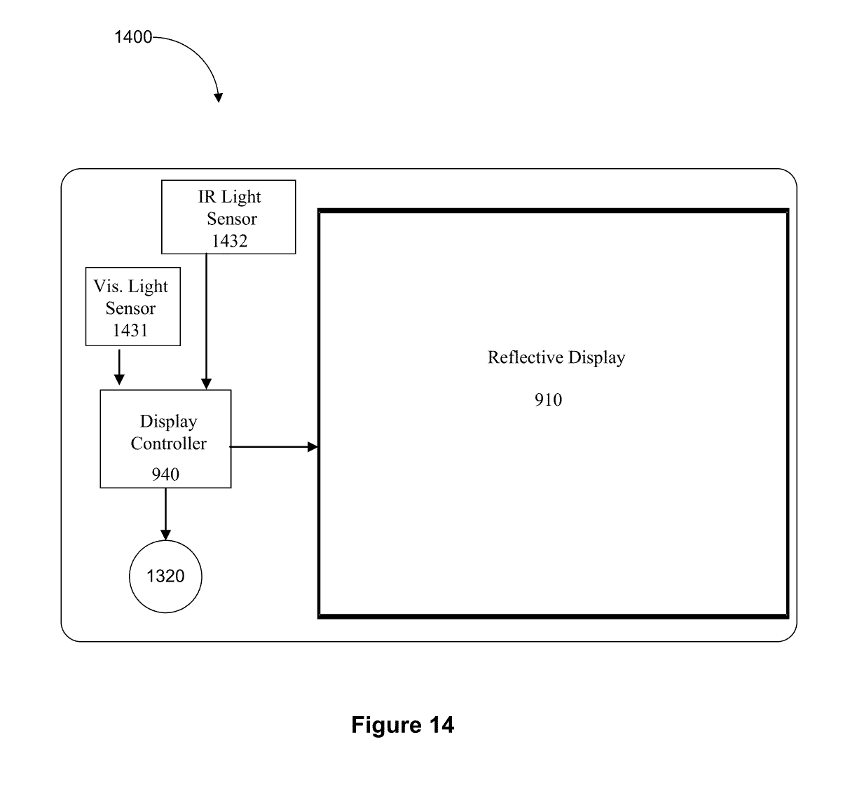

FIG. 14 shows an example of a block diagram of an electronic device having a reflective display. In the illustrated implementation, the electronic device 1400 may include the reflective display 910, and the display controller 940 and, in addition, a visible light sensor 1431 and an IR light sensor 1432 (which electronic devices 900 and 1300 do not necessarily include). The visible light sensor 1431 and the IR light sensor 1432, together or separately, may provide some or all of the functionality of the spectral sensing arrangement 930 described above. The visible light sensor 1431 and the IR light sensor 1432 may be configured to determine respective spectral characteristics of ambient light illuminating reflective display 910 and produce output signals representative thereof to the display controller 940. The display controller 940 may be configured, responsive to the signals output from the visible light sensor 1431 and the IR light sensor 1432, to dynamically adjust a color bias of the reflective display 910 by adjusting, for example, an intensity and/or a color of the auxiliary light source 1320. The display controller 940 may be configured to make a comparison of respective signals received from the visible light sensor 1431 and the IR light sensor 1432. Based on the comparison, the color bias of the reflective display 910 may be dynamically adjusted by adjusting an intensity and/or a color of supplemental light from the auxiliary light source 1320.

In addition, or alternatively, where the electronic device 1400 includes a color processing engine and the reflective display 910 includes a number of IMOD devices, the color processing engine may provide bi-level or analog control of the IMOD devices. In such implementations, the display controller 940 may be configured to dynamically adjust the color bias of the reflective display 910 by adjusting an output of the color processing engine.

It will be appreciated that the display controller 940 may be configured to process respective signals from the visible light sensor 1431 and the IR light sensor 1432 in various ways in order to make a comparison indicative of a relative intensity of ambient infrared light compared to ambient visible light. For example, a difference and/or a ratio of respective signals from the visible light sensor 1431 and the IR light sensor 1432 may be computed, with or without first normalizing the respective signals. As a further example, each respective signal may be compared to a standard, for example to CIE D65.

It will be understood that the visible light sensor 1431 and the IR light sensor 1432 may be separate components or may be monolithically integrated onto the same semiconductor substrate. Moreover, the visible light sensor 1431 and the IR light sensor 1432 may be disposed in a thin-film semiconducting film (for example, amorphous silicon, geranium indium gallium arsenide and/or lead sulfide). Similarly, the spectral sensing arrangement 930 may include one or more photodiodes, integrated onto the same semiconductor substrate or may be disposed in a thin-film semiconducting film.

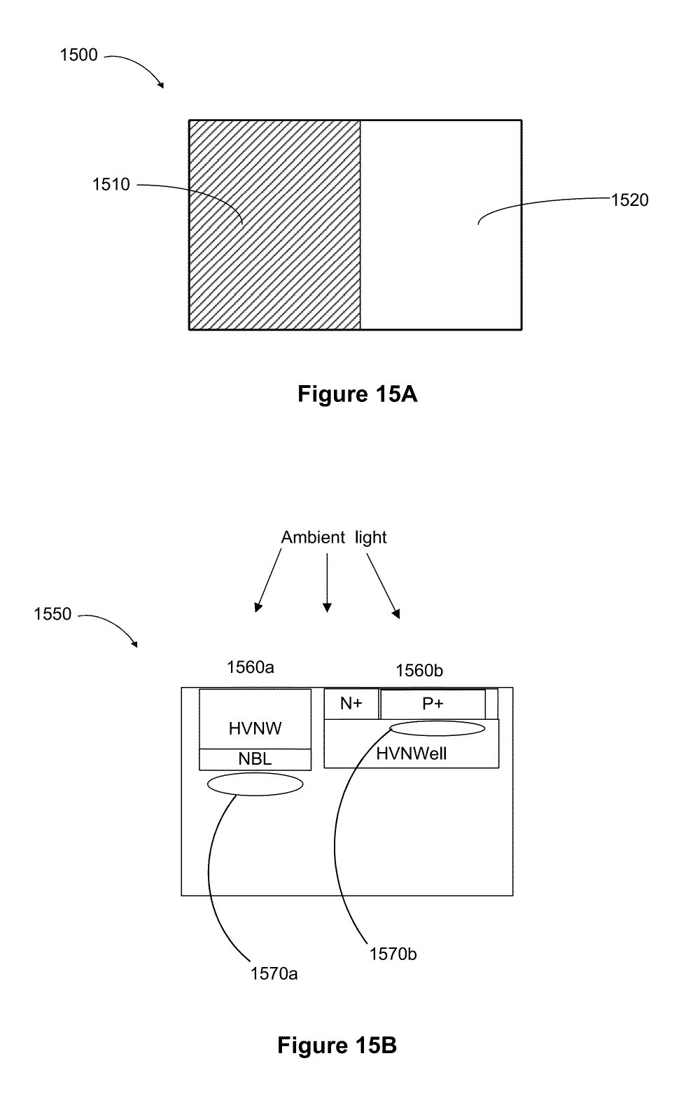

FIGS. 15A and 15B show examples of photodiodes configured to detect a spectrum characteristic of ambient light. Referring to FIG. 15A, a plan view of a photodiode 1500 is illustrated. In some implementations, the photodiode 1500 may be functionally separated into two portions, a first portion 1510 and a second portion 1520. The first portion 1510 of the photodiode 1500 may be configured to generate an output signal responsive to an intensity of ambient visible light, whereas the second portion 1520 of the photodiode 1500 may be configured to generate an output signal responsive to an intensity of ambient infrared light. This may be accomplished on a single semiconductor substrate by, for example, overlaying a filter, such as, for example, a thin film filter, over the first portion 1510 of photodiode 1500. The filter may be configured to substantially block infrared ambient light, while being substantially transparent to ambient visible light, for example.

Referring now to FIG. 15B, an alternative example of an implementation configured to detect a spectrum characteristic of ambient light is illustrated. In the illustrated implementation, respective photosensitive elements of one or more photodiodes may each be “tuned” such that each photosensitive element has a different respective sensitivity to a respective spectrum of electromagnetic radiation. In the illustrated implementation, for example, the photosensitive elements 1560a and 1560b are each configured with a respective depletion region 1570a and 1570b at a depth appropriate for detection of a particular respective wavelength of light or a particular range of wavelengths of light. For example, the photodiode 1560a may have a peak sensitivity to IR or near IR light whereas the photodiode 1560b may have a peak sensitivity to visible light.

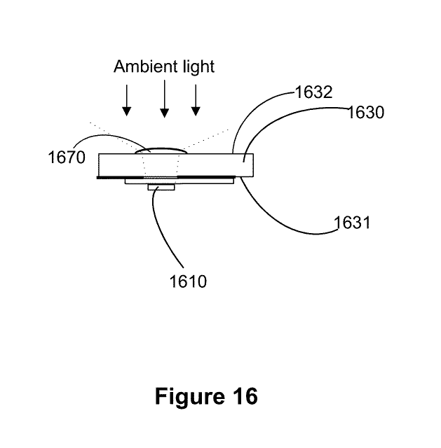

FIG. 16 shows an example of an implementation where a photodiode is disposed behind a lens. In the illustrated implementation, a photodiode 1610 is disposed behind a back surface 1631 of a cover glass 1630 and a lens 1670 is disposed on a front surface 1632 of the cover glass 1630. Other arrangements may be contemplated, however. For example, the lens 1670 may be embedded in the cover glass 1630. Moreover, the lens 1670 may be a collection of microlenses, for example. In some implementations, the lens 1670 may be configured so as to focus ambient light through the cover glass 1630 onto the photodiode 1610. In some implementations, the lens 1670 may be configured to gather light from a wider half angle, for example 60 degrees than would be possible in the absence of lens 1670. As a result of operation of lens 1670, efficiency of the photodiode 1610 may be increased and a photosensitive element of a smaller size may be employed.

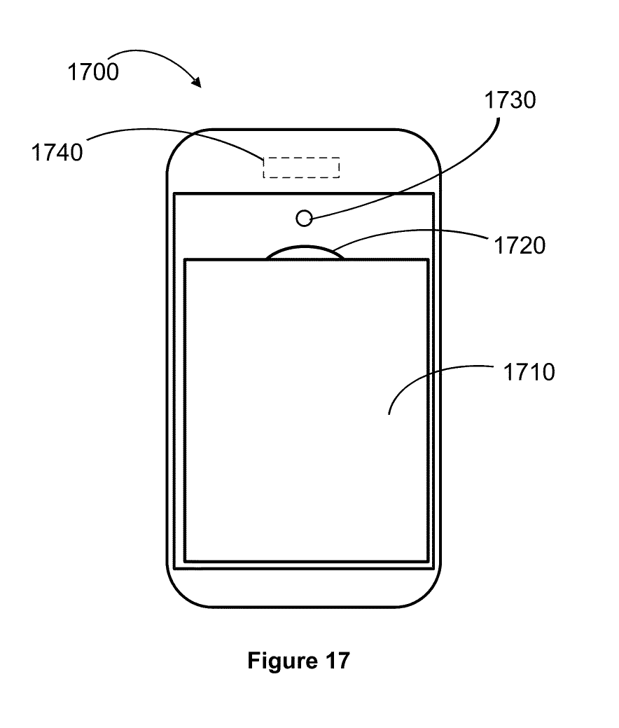

FIG. 17 shows an example of a personal electronic device (PED) having a reflective display. In the illustrated implementation, the PED 1700 includes a display 1710, a spectral sensing arrangement 1730 and a display controller 1740. The PED 1700 may include, for example a cellular telephone, mobile television receiver, wireless device, smartphone, bluetooth device, personal data assistant (PDA), wireless electronic mail receiver, hand-held or portable computer, netbook, notebook, smartbook, tablet, GPS receiver/navigator, camera and/or camera view display, MP3 player, camcorder, game console, wrist watch, clock, calculator, electronic reading device (e.g., e-reader), DVD player, CD player, or any electronic device.

The shape of the display 1710 may be, as illustrated, substantially rectangular, but other shapes, such as square or oval also may be used. The display 1710 may be made of glass, plastic, or other material. The display 1710 may include a reflective display, such as displays including reflective IMODs as discussed herein. In some other implementations, the display 1710 may include a transflective display.

The PED 1700 may include an auxiliary light source 1720 configured to provide supplemental light to the display 1710. In some implementations, the auxiliary light source 1720 may include a front-light, e.g., for a reflective display. In some other implementations, the auxiliary light source 1720 may include a back-light, e.g., for a transflective display. The auxiliary light source 1720 may be any type of light source(s), e.g., one or more white or color light emitting diodes (LED). In some implementations, a light guide (not shown) may be used to receive light from the auxiliary light source 1720 and guide the light to one or more portions of the display 1710.

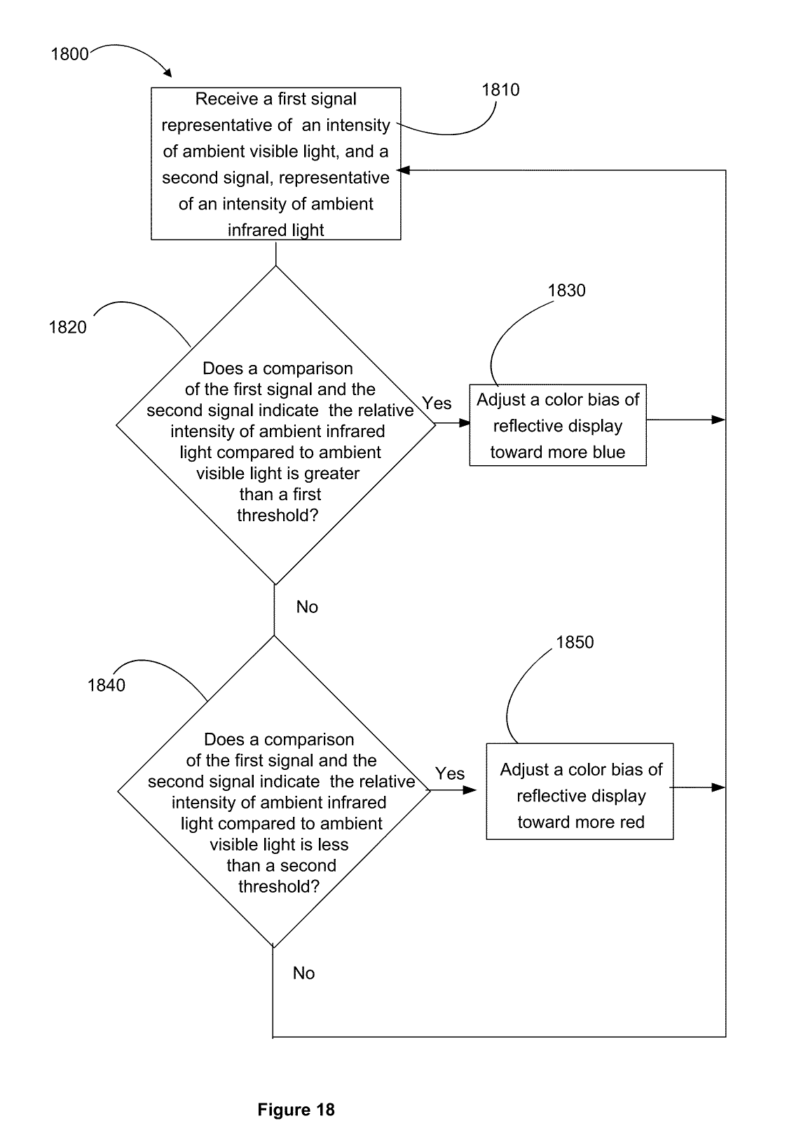

FIG. 18 shows an example of a method for adjusting a color bias of a reflective display based on analysis of signals output from a spectral sensing arrangement. In an implementation, the signal analysis of the method 1800 may be performed by the display controller 940 as depicted in FIGS. 9-14. The method may begin at block 1810 with receiving, periodically or continuously, signals output by a spectral sensing arrangement. The signals may be received from a single spectral sensing arrangement 930 outputting at least two output signals, a first signal representative of an intensity of ambient visible light, and a second signal, representative of an intensity of ambient infrared light. Alternatively, respective signals may be received separately from a visible light sensor and an IR light sensor. In an implementation, respective signals may be received separately from an ALS and an IR proximity sensor.

At block 1820, a comparison may be made of the first signal and the second signal to determine whether the comparison indicates that the relative intensity of ambient infrared compared to ambient visible light is greater than a first threshold. Advantageously, the first threshold may be set to such a value that differences in the relative intensities of ambient infrared light compared to ambient visible light that are significant enough to effect a user's perception of display quality, result in a determination to adjust a color bias of the display.

The first threshold may be predefined and/or fixed; however in some implementations, the threshold may be adjustable based on other ambient conditions (such as general levels of ambient conditions such as natural daylight, dark, indoor or outdoor artificial illumination, and/or rate of change of those ambient conditions), user preferences, and/or content of image to be displayed. If at block 1820, a determination is made that the relative intensity of ambient infrared compared to ambient visible light is not greater than the first threshold, the method may proceed to block 1840.

On the other hand, if a determination is made that the relative intensity of ambient infrared compared to ambient visible light is greater than the first threshold, the method may proceed to block 1830. At block 1830, a color bias of the reflective display is adjusted toward more blue. In some implementations, the color bias may be adjusted by adjusting, with the display controller, one or both of an intensity and a color of an auxiliary light source, such as, for example, a front light of the reflective display. In another implementation, the color bias may be adjusted by adjusting, with the display controller, an output of a color processing engine that provides bi-level or analog control of IMOD devices incorporated in the reflective display.

Following adjustment of the color bias at block 1830, the method may return to block 1810, either immediately, or after an interval of time.

If at block 1820 the determination is made that the relative intensity of ambient infrared compared to ambient visible light is not greater than the first threshold, the method may proceed to block 1840. At block 1840, a comparison may be made of the first signal and the second signal to determine whether the comparison indicates that the relative intensity of ambient infrared compared to ambient visible light is less than a second threshold. In some implementations, the second threshold may be set to such a value that differences in the relative intensities of ambient infrared light compared to ambient visible light that are significant enough to effect a user's perception of display quality, result in a determination to adjust a color bias of the display.

The second threshold may be predefined and/or fixed; however in some implementations, the second threshold may be adjustable based on other ambient conditions (such as general levels of ambient conditions such as natural daylight, dark, indoor or outdoor artificial illumination, and/or rate of change of those ambient conditions), user preferences, and/or content of image to be displayed. If at block 1840, a determination is made that the relative intensity of ambient infrared compared to ambient visible light is not less than the first threshold, the method may return to block 1810, either immediately, or after an interval of time.

On the other hand, if at block 1840 a determination is made that the relative intensity of ambient infrared light compared to ambient visible light is less than the second threshold, the method may proceed to block 1850. At block 1850, a color bias of the reflective display may be adjusted toward more red. In some implementations, the color bias may be adjusted by adjusting, with the display controller, one or both of an intensity and a color of an auxiliary light source, such as, for example, a front light of the reflective display. In another implementation, the color bias may be adjusted by adjusting, with the display controller, an output of a color processing engine that provides bi-level or analog control of IMOD devices incorporated in the reflective display.

Following adjustment of the color bias at block 1850, the method may return to block 1810, either immediately, or after an interval of time.

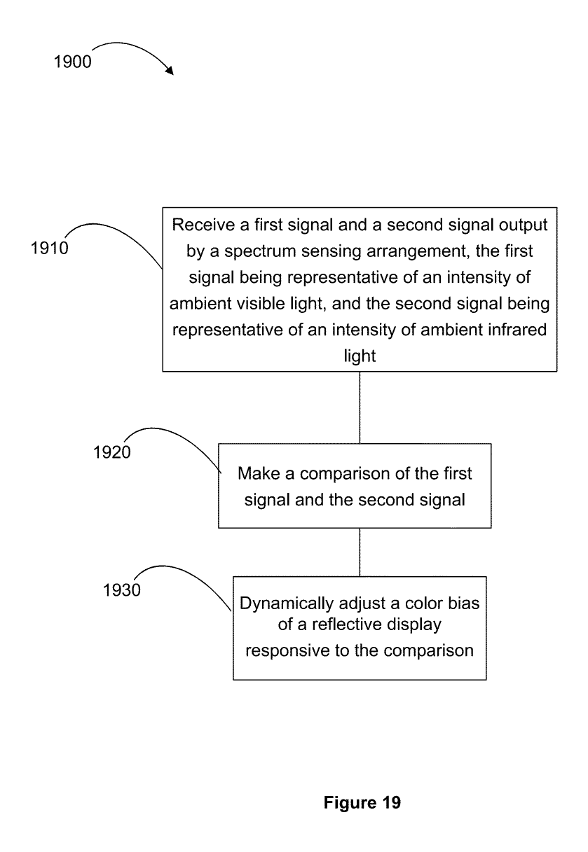

FIG. 19 shows an example of a method for adjusting a color bias of a reflective display. The method 1900 may begin at block 1910. A first signal and a second signal may be received from a spectrum sensing arrangement, the first signal being representative of an intensity of ambient visible light, and the second signal being representative of an intensity of ambient infrared light. In some implementations, the spectrum sensing arrangement may include a photodiode, a first portion of the photodiode being configured to generate the first signal, and a second portion of the photodiode being configured to generate the second signal. In some implementations, the spectrum sensing arrangement may include a visible light sensor and an IR light sensor. In some implementations, the spectrum sensing arrangement may include an ALS and an IR proximity sensor.

At block 1920, a comparison of the first signal and the second signal may be made by, for example a display controller. The comparison may indicate a relative intensity of ambient infrared light compared to ambient visible light.

At block 1930, a color bias of the reflective display may be dynamically adjusted, responsive to the comparison. The dynamic adjustment may be performed in accordance with method 1800 described herein above. As a result, a color bias of the reflective display is adjusted so as to prevent degradation of image quality that would otherwise occur as a result of changing spectral characteristics of ambient light.

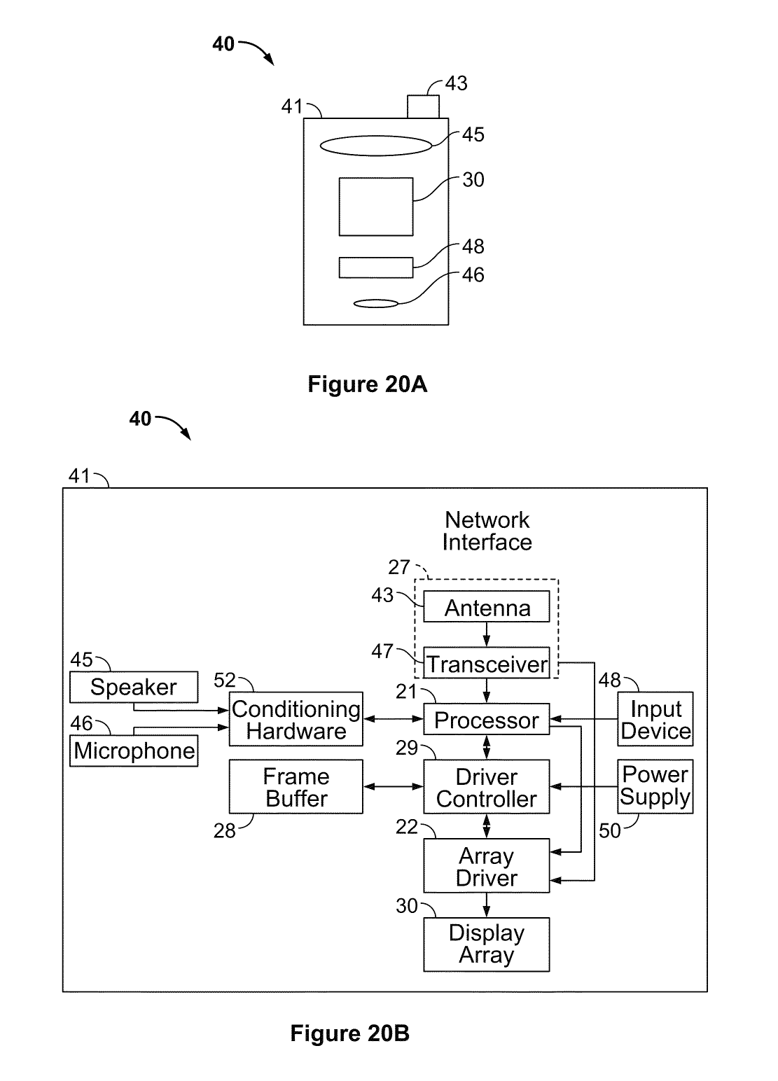

FIGS. 20A and 20B show examples of system block diagrams illustrating a display device 40 that includes a plurality of IMODs. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD display, as described herein.

The components of the display device 40 are schematically illustrated in FIG. 20B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a reflective display;
a spectrum sensing arrangement including a photodiode, a first portion of the photodiode being configured to generate a first signal, the first signal being representative of an intensity of ambient visible light, and a second portion of the photodiode being configured to generate a second signal, the second signal being representative of an intensity of ambient infrared light; and
a display controller in communication with the spectrum sensing arrangement, the display controller configured to:
make a comparison of the first signal and the second signal; and
dynamically adjust a color bias of the reflective display responsive to the comparison.

2. The apparatus of claim 1, wherein the comparison indicates a relative intensity of ambient infrared light compared to ambient visible light.

3. The apparatus of claim 2, wherein the display controller is configured to adjust the color bias of the reflective display toward more blue when the relative intensity of ambient infrared light compared to ambient visible light is greater than a first threshold, and to adjust the color bias of the reflective display toward more red when the relative intensity of ambient infrared light compared to ambient visible light is less than a second threshold.

4. The apparatus of claim 3, wherein the display controller is configured to access one or both of a look-up table (LUT) and a formula that provides a target color bias corresponding to the comparison, and to dynamically adjust, responsive to the comparison, the color bias toward the target color bias.

5. The apparatus of claim 1, further including an auxiliary light source, wherein the display controller is configured to dynamically adjust the color bias of the reflective display by adjusting one or both of an intensity and a color of the auxiliary light source.

6. The apparatus of claim 5, wherein the auxiliary light source includes a front light.

7. The apparatus of claim 1, wherein:
the apparatus includes a color processing engine;
the reflective display includes a plurality of interferometric modulator (IMOD) devices;
the color processing engine provides bi-level or analog control of the IMOD devices; and
the display controller is configured to dynamically adjust the color bias by adjusting an output of the color processing engine.

8. The apparatus of claim 1, further comprising:
a processor that is configured to communicate with the reflective display, the processor being configured to process image data; and
a memory device that is configured to communicate with the processor.

9. The apparatus of claim 8, further comprising:
a driver circuit configured to send at least one signal to the display; and
a controller configured to send at least a portion of the image data to the driver circuit.

10. The apparatus of claim 8, further including an image source module configured to send the image data to the processor, wherein the image source module includes one or more of a receiver, transceiver, and transmitter.

11. The apparatus of claim 8, further comprising:
an input device configured to receive input data and to communicate the input data to the processor.

12. An apparatus comprising:
a reflective display;
a spectrum sensing arrangement;
an auxiliary light source; and
a display controller in communication with the spectrum sensing arrangement, the display controller configured to dynamically adjust a color bias of the reflective display by adjusting one or both of an intensity and a color of the auxiliary light source, responsive to a comparison of at least a first signal and a second signal from the spectrum sensing arrangement, the first signal being indicative of an intensity of ambient visible light, and the second signal being representative of an intensity of ambient infrared light.

13. The apparatus of claim 12 wherein the spectrum sensing arrangement includes a photodiode, a first portion of the photodiode being configured to generate the first signal, and a second portion of the photodiode configured to generate the second signal.

14. The apparatus of claim 13, wherein the comparison indicates a relative intensity of ambient infrared light compared to ambient visible light.

15. The apparatus of claim 14, wherein the display controller is configured to adjust the color bias of the reflective display toward more blue when the relative intensity of ambient infrared light compared to ambient visible light is greater than a first threshold, and to adjust the color bias of the reflective display toward more red when the relative intensity of ambient infrared light compared to ambient visible light is less than a second threshold.

16. The apparatus of claim 12, wherein the auxiliary light source includes a front light.

17. The apparatus of claim 12, wherein:
the apparatus includes a color processing engine;
the reflective display includes a plurality of interferometric modulator (IMOD) devices;
the color processing engine provides bi-level or analog control of the IMOD devices; and
the display controller is configured to dynamically adjust the color bias by adjusting an output of the color processing engine.

18. A portable electronic device (PED) comprising:
a reflective display;
an ambient light sensor;
an infrared (IR) proximity sensor; and
a display controller configured to dynamically adjust a color bias of the reflective display responsive to a comparison of at least a first signal from the ambient light sensor and a second signal from the IR proximity sensor.

19. The PED of claim 18, wherein the comparison indicates a relative intensity of ambient infrared light compared to ambient visible light.

20. The PED of claim 19, wherein the display controller is configured to:
adjust the color bias of the reflective display toward more blue when the relative intensity of ambient infrared light compared to ambient visible light is greater than a first threshold; and
adjust the color bias of the reflective display toward more red when the relative intensity of ambient infrared light compared to ambient visible light is less than a second threshold.

21. The PED of claim 18, further including an auxiliary light source, wherein the display controller is configured to dynamically adjust the color bias of the reflective display by adjusting one or both of an intensity and a color of the auxiliary light source.

22. The PED of claim 18, wherein:
the apparatus includes a color processing engine;
the reflective display includes a plurality of interferometric modulator (IMOD) devices;
the color processing engine provides bi-level or analog control of the IMOD devices; and
the display controller is configured to dynamically adjust the color bias by adjusting an output of the color processing engine.

23. A method comprising:
receiving, at a display controller, a first signal and a second signal output by a spectrum sensing arrangement including a photodiode, a first portion of the photodiode being configured to generate a first signal, the first signal being representative of an intensity of ambient visible light, and a second portion of the photodiode being configured to generate a second signal, the second signal being representative of an intensity of ambient infrared light, and, with the display controller:
making a comparison of the first signal and the second signal; and
dynamically adjusting a color bias of a reflective display responsive to the comparison.

24. The method of claim 23, wherein the comparison indicates a relative intensity of ambient infrared light compared to ambient visible light.

25. The method of claim 24, wherein dynamically adjusting the color bias of the reflective display responsive to the comparison includes adjusting the color bias of the reflective display toward more blue when the relative intensity of ambient infrared light compared to ambient visible light is greater than a first threshold, and to adjust the color bias of the reflective display toward more red when the relative intensity of ambient infrared light compared to ambient visible light is less than a second threshold.

26. The method of claim 24, wherein dynamically adjusting the color bias of the reflective display responsive to the comparison includes adjusting one or both of an intensity and a color of an auxiliary light source associated with the reflective display.

27. An apparatus comprising:
means for outputting, to a display controller, a first signal and a second signal, the first signal being representative of an intensity of ambient visible light, the second signal being representative of an intensity of ambient infrared light, and, with the display controller:
making a comparison of the first signal and the second signal; and
dynamically adjusting a color bias of a reflective display responsive to the comparison.

28. The apparatus of claim 27, wherein the comparison indicates a relative intensity of ambient infrared light compared to ambient visible light.

29. The apparatus of claim 28, wherein the display controller is configured to adjust the color bias of the reflective display toward more blue when the relative intensity of ambient infrared light compared to ambient visible light is greater than a first threshold, and to adjust the color bias of the reflective display toward more red when the relative intensity of ambient infrared light compared to ambient visible light is less than a second threshold.

30. A computer-readable storage medium having stored thereon instructions which, when executed by a computing system, cause the computing system to perform operations, the operations comprising:
receiving, a first signal and a second signal output by a spectrum sensing arrangement including a photodiode, a first portion of the photodiode being configured to generate a first signal, the first signal being representative of an intensity of ambient visible light, and a second portion of the photodiode being configured to generate a second signal, the second signal being representative of an intensity of ambient infrared light;
making a comparison of the first signal and the second signal; and
dynamically adjusting a color bias of a reflective display responsive to the comparison.

31. The storage medium of claim 30, wherein the comparison indicates a relative intensity of ambient infrared light compared to ambient visible light.

32. The storage medium of claim 31, wherein dynamically adjusting the color bias of the reflective display responsive to the comparison includes adjusting the color bias of the reflective display toward more blue when the relative intensity of ambient infrared light compared to ambient visible light is greater than a first threshold, and to adjust the color bias of the reflective display toward more red when the relative intensity of ambient infrared light compared to ambient visible light is less than a second threshold.

33. The storage medium of claim 30, wherein dynamically adjusting the color bias of the reflective display responsive to the comparison includes adjusting one or both of an intensity and a color of an auxiliary light source associated with the reflective display.

34. The storage medium of claim 30, wherein dynamically adjusting a color bias of a reflective display responsive to the comparison includes:
accessing one or both of a look-up table (LUT) and a formula that provides a target color bias corresponding to the comparison, and dynamically adjusting the color bias toward the target color bias.
